(19) United States
(12) Patent Application Publication
(10) Pub. No.: US 2018/0215032 A1
(43) Pub. Date: Aug. 2, 2018

(54) SCRAPER HOLDER AND PROCESS FOR MAKING THE SAME

(71) Applicant: HONG JIN INDUSTRY CO.,LTD., Taichung (TW)

(72) Inventor: Chung Tsai, Taichung (TW)

(21) Appl. No.: 15/419,164

(22) Filed: Jan. 30, 2017

(51) Int. Cl. B25G 1/10; B26B 5/00

(52) U.S. Cl. CPC B25G 1/10; B26B 5/006

(57) ABSTRACT

A process for making a holder for a scraper includes the step of providing a metal sheet. Then, the metal sheet is cut into a semi-product. The semi-product includes a transverse strip including at least one slit to provide at least one flip, a middle longitudinal strip extending from the transverse strip, and two longitudinal strips extending from the transverse strip. Then, the semi-product is pressed to bend the flip from the transverse strip and turn the slit into apertures. The flip is used as a lower jaw and other portions of the transverse strip are used as upper jaws.

### BACKGROUND OF INVENTION

### 1. Field of Invention

The present invention relates to a holder for a scraper and, more particularly, to a process for making a holder for a scraper.

### 2. Related Prior Art

Referring to FIGS. 9 to 13, a conventional process for making a holder for a scraper is shown. At 40, two metal sheets 50 and 60 are provided. At 42, the metal sheet 50 is cut so that it includes a transverse strip 51, a middle longitudinal strip 53 and two lateral longitudinal strips 54. The longitudinal strips 53 and 54 extend from the transverse strip 51. At 44, the transverse strip 51 is pressed so that it includes an arched portion 52 between two flat portions 55 and 57. Moreover, the middle longitudinal strip 53 is pressed so that it includes a connective portion. The metal sheet 60 is punched so that it includes an inverted arched portion 62 between two flat portions 65 and 67. At 46, the flat portion 57 of the metal sheet 50 is connected to the flat portion 67 of the metal sheet 60 by welding. The arched portion 52 of the metal sheet 50 is separated from the inverted arched portion 62 of the metal sheet 60 by a space 70 for receiving a portion of a scraper. The flat portion 55 of the metal sheet 50 and the flat portion 67 of the metal sheet 60 are used as two jaws of a clip. The conventional process is complicated for several reasons. Firstly, it involves providing and pressing two metal sheets. Secondly, it involves welding to interconnect two metal sheets. Moreover, the holder is expensive for including two metal sheets.

The present invention is therefore intended to obviate or at least alleviate the problems encountered in prior art.

### SUMMARY OF INVENTION

It is the primary objective of the present invention to provide a simple process for making an inexpensive holder for a scraper.

To achieve the foregoing objective, the process includes the step of providing a metal sheet. Then, the metal sheet is cut into a semi-product. The semi-product includes a transverse strip including at least one slit to provide at least one flip, a middle longitudinal strip extending from the transverse strip, and two longitudinal strips extending from the transverse strip. Then, the semi-product is pressed to bend the flip from the transverse strip and turn the slit into apertures. The flip is used as a lower jaw and other portions of the transverse strip are used as upper jaws.

Other objectives, advantages and features of the present invention will be apparent from the following description referring to the attached drawings.

### BRIEF DESCRIPTION OF DRAWINGS

The present invention will be described via detailed illustration of three embodiments versus the prior art referring to the drawings wherein:

FIG. 1 is a flow chart of a process for making a holder according to the preferred embodiment of the present invention;

FIG. 2 is a perspective view of a metal sheet to be processed in the process shown in FIG. 1;

FIG. 3 is a perspective view of the metal sheet punched in the process shown in FIG. 1;

FIG. 4 is a perspective view of a holder made in the process shown in FIG. 1;

FIG. 5 is a perspective view of a holder according to the second embodiment of the present invention;

FIG. 6 is a front view of the holder shown in FIG. 5;

FIG. 7 is a side view of the holder shown in FIG. 5;

FIG. 8 is a perspective view of a holder according to the third embodiment of the present invention;

FIG. 9 is a flow chart of a conventional process for making a holder for a scraper;

FIG. 10 is a perspective view of two metal sheets to be processed in the process shown in FIG. 9;

FIG. 11 is a perspective view of the metal sheets punched in the process shown in FIG. 9;

FIG. 12 is a perspective view of the metal sheets pressed in the process shown in FIG. 9; and

FIG. 13 is a perspective view of a holder made in the process shown in FIG. 9.

### DETAILED DESCRIPTION OF PREFERRED EMBODIMENT

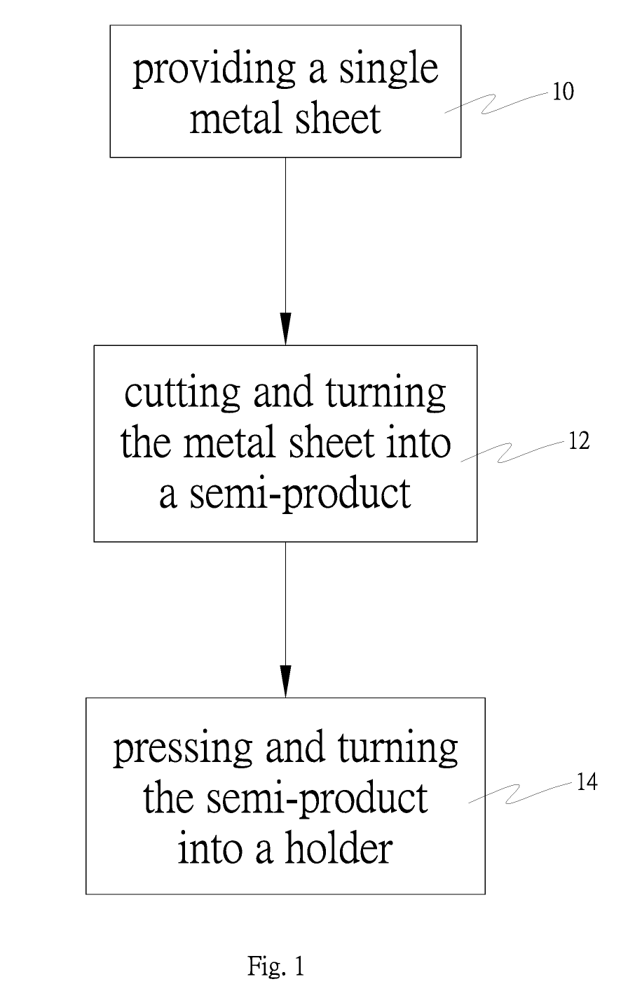

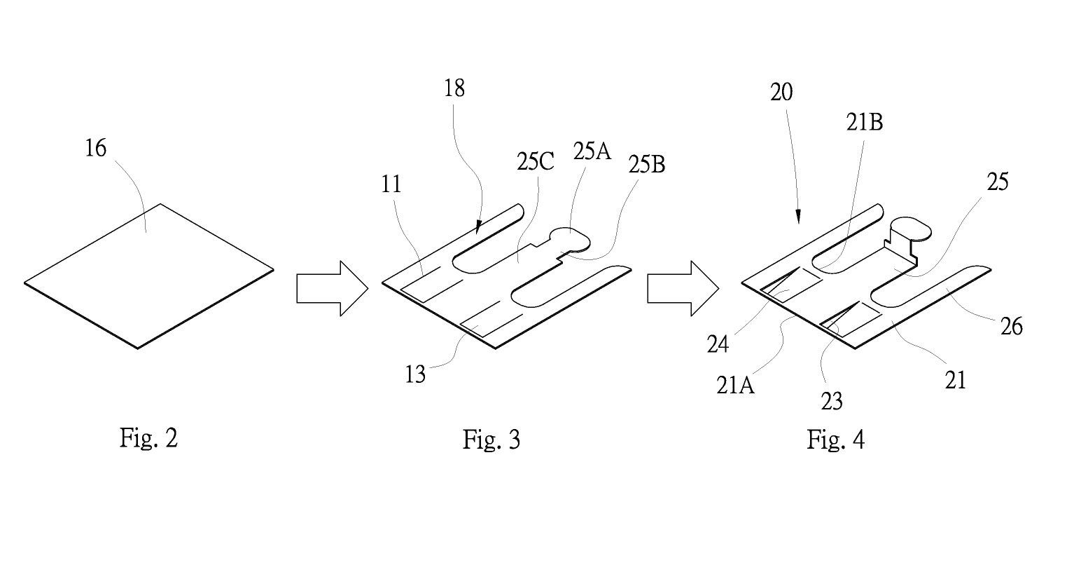

Referring to FIG. 1, there is a process for making a holder for a scraper according to the preferred embodiment of the present invention. Referring to FIGS. 1 and 2, at 10, a single metal sheet 16 is provided.

Referring to FIGS. 1 and 3, at 12, the metal sheet 16 is cut and turned into a semi-product 18 that includes a transverse strip 21, a middle longitudinal strip 25 and two lateral longitudinal strips 26. The longitudinal strips 25 and 26 extend from the transverse strip 21. The transverse strip 21 is cut and hence made with two slits 11 each extending along a U-shaped path, thereby making a flip 13. The middle longitudinal strip 25 includes a button 25A, a narrow portion 25B and a broad portion 25C. The broad portion 25C extends from the transverse strip 21. The narrow portion 25B extends from the broad portion 25C. The button 25A extends from the narrow portion 25B. The semi-product 18 is a flat element, i.e., the transverse strip 21, the middle longitudinal strip 25 and the lateral longitudinal strips 26 extend in a same plane.

Referring to FIGS. 1 and 4, at 14, the semi-product 18 is pressed and turned into a holder 20. The flips 13 are bent and turned into lower jaws 24. Portions of the transverse strip 21 are used as upper jaws. Accordingly, the slits 11 are turned into apertures. The middle longitudinal strip 25 is bent so that the broad portion 25C extends in a same plane with the transverse strip 21. Moreover, the narrow portion 25B extends perpendicular to the broad portion 25C. Furthermore, the button 25A extends perpendicular to the narrow portion 25B. The lateral longitudinal strips 26 are bent so that they do not extend in a same plane with the transverse strip 21.

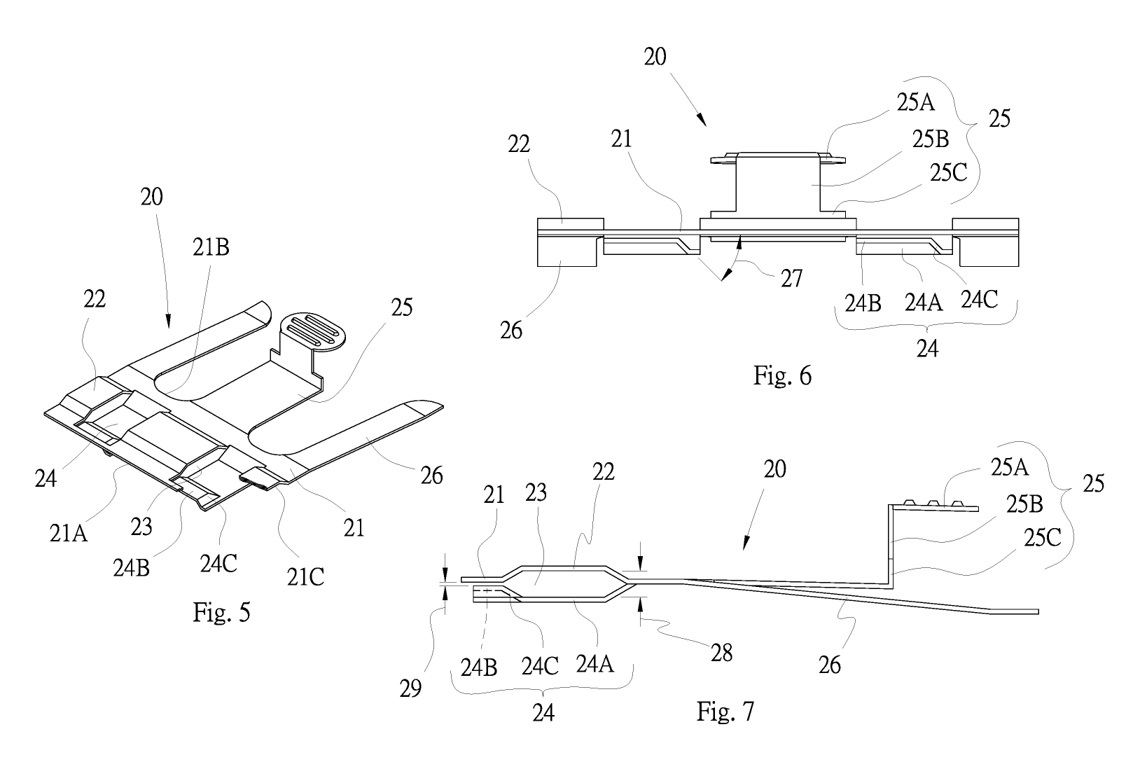

Referring to FIGS. 5 through 7, there is a holder according to a second embodiment of the present invention. The second embodiment is like the first embodiment except for several things. Firstly, the transverse strip 21 includes three arched portions used as upper jaws 22. Each of the upper jaws 22 is formed between a front portion 21A and a rear portion 21B of the transverse strip 21.

Secondly, the lower jaws 24 are inverted arched elements instead of flat elements. Each of the lower jaws 24 includes an inverted arched portion 24A extending from the rear portion 21B of the transverse strip 21 and a flat portion 24B extending from the inverted arched portion 24A toward the front portion 21A of the transverse strip 21. The flat portion 24B is located higher than the inverted arched portion 24A. There is a space 23 defined between the upper jaws 22 and the lower jaws 24. The inverted arched portions 24A of the lower jaws 24 are at a distance 28 from the upper jaws 22. The flat portions 24B are separated from the front portion 21A of the transverse strip 21 by a gap 29. The thickness of the gap 29 is preferably smaller than that of a scraper.

The front portion 21A of the transverse strip 21 and the flat portions 24B are used to clip a portion of a scraper when another portion of the scraper is inserted in the space 23.

Thirdly, each of the lower jaws 24 includes an inclined portion 24C formed between the flat portion 24B and the inverted arched portion 24A. There is a sharp angle 27 between the inclined portion 24C of each of the jaws 24 and the transverse strip 21. The inclined portions 24C of the lower jaws 24 are used to facilitate the movement of the scraper into or from the gap 29 between the flat portions 24B and the front portion 21A of the transverse strip 21. The angle 27 is 30° to 60°.

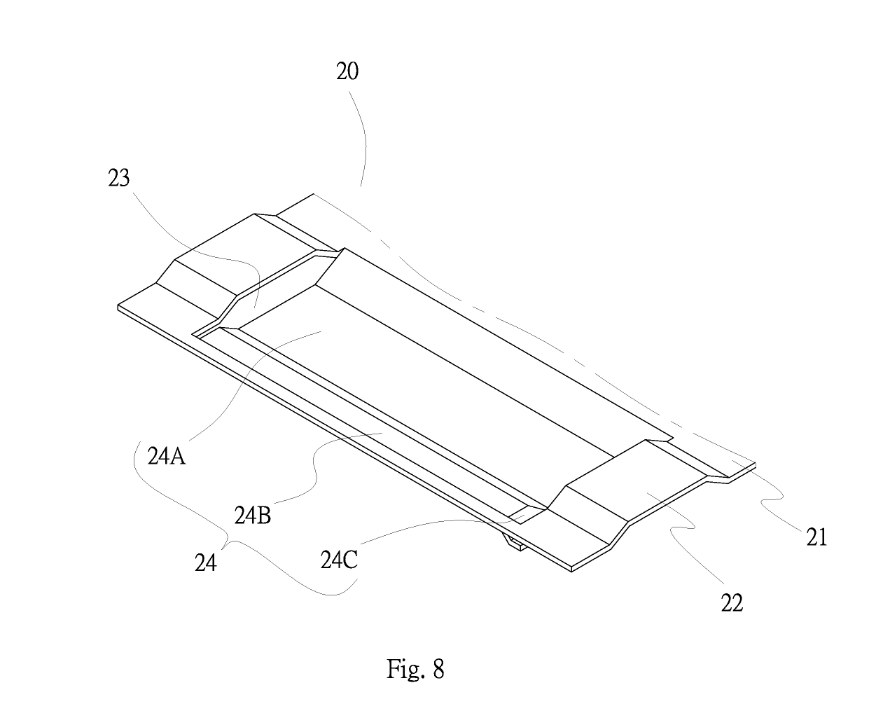

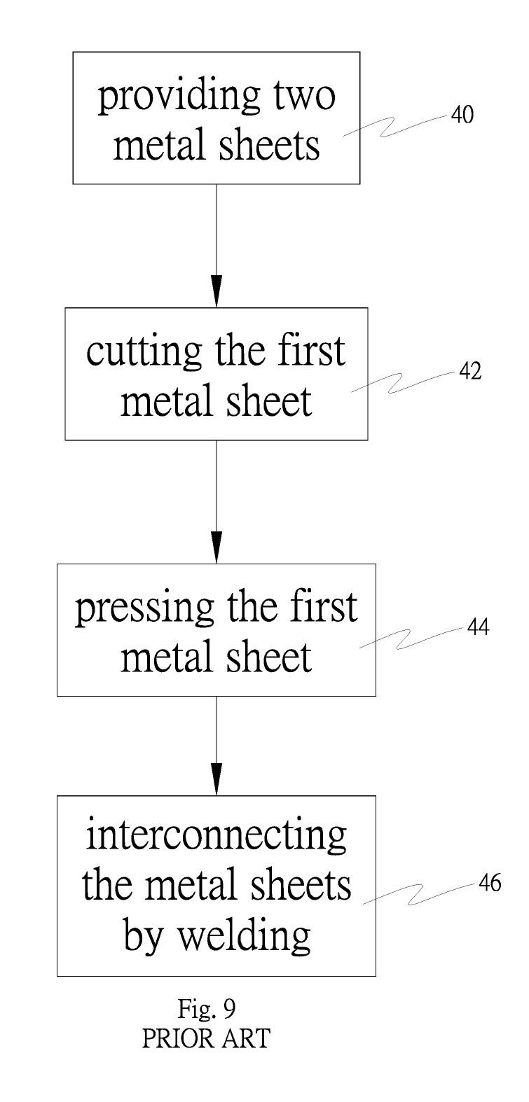

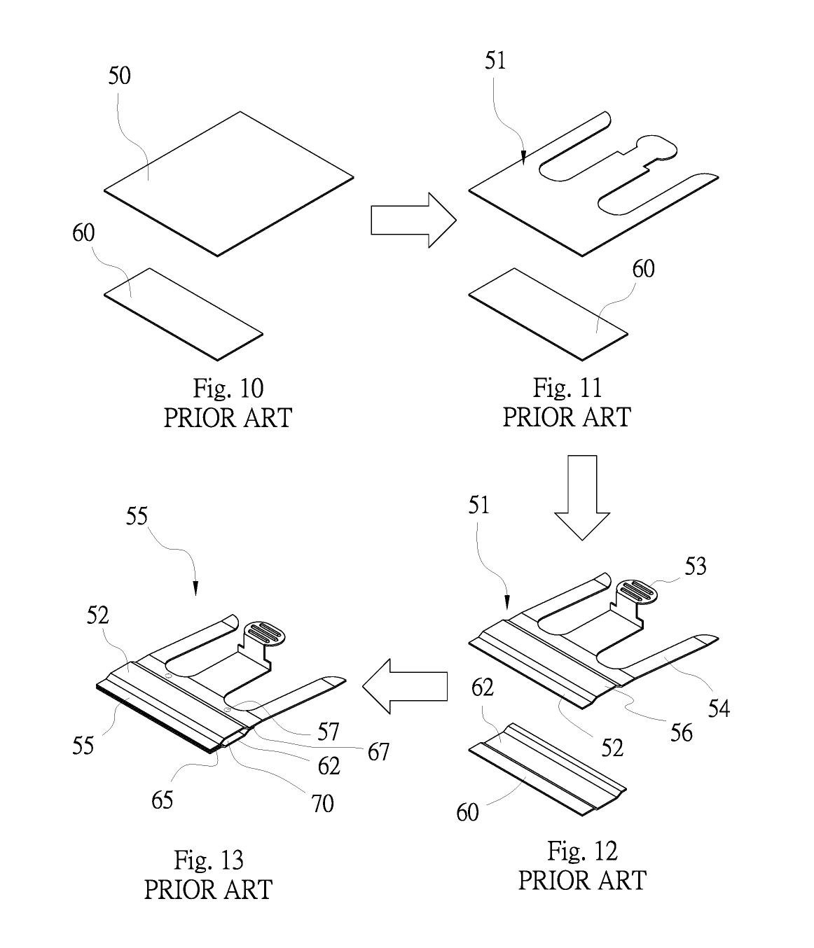

Referring to FIG. 8, there is a holder 30 according to a third embodiment of the present invention. The third embodiment is identical to the second embodiment except for two things. Firstly, there are two upper jaws 22 instead of three. Secondly, there is only one lower jaw 24 instead of two. The width of the single lower 24 in the third embodiment is larger than that of each of the lower jaws 24 in the second embodiment.

The present invention has been described via the illustration of the embodiments. Those skilled in the art can derive variations from the embodiments without departing from the scope of the present invention. Therefore, the embodiments shall not limit the scope of the present invention defined in the claims.

1. A process for making a holder for a scraper comprising the steps of:
providing a metal sheet;
cutting the metal sheet into a semi-product that comprises:
a transverse strip comprising at least one slit to provide at least one flip;
a middle longitudinal strip extending from the transverse strip; and
two longitudinal strips extending from the transverse strip;
pressing the semi-product to bend the flip from the transverse strip and turn the slit into apertures, wherein the flip is used as a lower jaw and other portions of the transverse strip are used as upper jaws.

2. The process according to claim 1, wherein the step of pressing the semi-product comprises the step of pressing the transverse strip so that the transverse strip comprises a front portion, a rear portion and at least two arched portions formed between the front and rear portions.

3. The process according to claim 2, wherein the step of pressing the semi-product comprises the step of pressing the flip and turning it into a jaw that comprises an inverted arched portion extending from the rear portion of the transverse strip and a flat portion extending from the inverted arched portion toward the front portion of the transverse strip, wherein there is a gap between the flat portion and the transverse strip, wherein the inverted arched portion of the jaw is at a distance from the arched portions of the transverse strip.

4. The process according to claim 3, wherein the step of pressing the semi-product comprises the step of cutting the jaw to provide an inclined portion between the inverted arched portion and the flat portion.

5. The process according to claim 1, wherein the step of pressing the semi-product further comprises the step of bending the middle longitudinal strip so that it comprises a broad portion extending from the transverse strip, a narrow portion transversely extending from the broad portion, and a button transversely extending from the narrow portion, wherein the broad portion of the middle longitudinal strip extends in a same plane with the transverse strip, wherein the button extends parallel to the broad portion of the middle longitudinal strip, wherein the lateral longitudinal strips do not extend in a same plane with the transverse strip.

6. A holder comprising a transverse strip comprising:
a front portion;
a rear portion;
at least two arched upper jaws formed between the front and rear portions; and
at least one lower jaw comprising an inverted arched portion extending from the rear portion, a flat portion extending from the inverted arched portion, a space between the inverted arched portion and the upper jaws, and a gap between the flat portion and the front portion, wherein the gap is in communication with the space.

7. The holder according to claim 6, wherein the lower jaw further comprises an inclined portion formed between the inverted arched portion and the flat portion, wherein there is a sharp angle between the inclined portion and the transverse strip.

8. The holder according to claim 7, wherein the angle is 30° to 60°.

9. The holder according to claim 6, further comprising:
two lateral longitudinal strips extending from the transverse strip, wherein there is an angle of larger than 90° between the lateral longitudinal strips and the transverse strip; and
a middle longitudinal strip comprising a broad portion extending from the transverse strip, a narrow portion transversely extending from the broad portion, and a button transversely extending from the narrow portion, wherein the broad portion of the middle longitudinal strip extends in a same plane with the transverse strip, wherein the button extends parallel to the broad portion of the middle longitudinal strip, wherein the lateral longitudinal strips do not extend in a same plane with the transverse strip.
